(19) United States
(12) Patent Application Publication
(10) Pub. No.: US 2026/0181088 A1
(43) Pub. Date: Jun. 25, 2026

(54) PRINTER COMMUNICABLE WITH INFORMATION PROCESSING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Kazushige SHIMADA, Kanagawa (JP)

(21) Appl. No.: 19/411,824

(22) Filed: Dec. 8, 2025

(30) Foreign Application Priority Data
Dec. 24, 2024 (JP) 2024-227790

(51) Int. Cl. H04N 1/00

(52) U.S. Cl. CPC H04N 1/00771; H04N 1/00694; H04N 1/00708

(57) ABSTRACT

A technique that enables a printer to perform appropriate printing even if an information processing apparatus has a low processing capability. The printer is communicable with the information processing apparatus. The printer includes a memory device that stores a set of instructions, and at least one processor that executes the set of instructions to receive first information relating to media selected by a user in the information processing apparatus, and output second information to print on the media selected in a case where the media selected is not placed in the printer.

### BACKGROUND

### Field of the Technology

The aspect of the embodiments relates to a printer communicable with an information processing apparatus, a control method therefor, and a storage medium storing a control program therefor.

### Description of the Related Art

In standard printing, a printer has conditions (for example, a media size, a media feed port, a media type, a direction, rotation, etc.) that can be set for media as combination data for all kinds of media or combination data for currently placed media. In the standard printing, the data of the combinations for all kinds of media is referred to as “media-col-database”, and the data of the combinations for the currently placed media is referred to as “media-col-ready”. In this specification, “media” means a sheet like a paper sheet on which an image can be printed by a printer.

“PWG5100.7 - 2023 IPP Job Extensions v2.1”, The Printer Working Group,2023, p.39 discloses a technique that an information processing apparatus narrows down combinations to settable combinations based on a selection by a user and that can form an appropriate image on media supported by a printer, by using these combination data. In particular, when a media type that a user wants to print is an envelope, the information processing apparatus is required to more correctly grasp parameters such as an orientation and rotation than a normal media type and to form an appropriate image due to characteristics of a media feed method of an envelope in the printer.

A data size of the media-col-database tends to be large. Therefore, the information processing apparatus such as a mobile terminal that emphasizes a real-time property from a viewpoint of a user experience tends to avoid obtaining the media-col-database and to obtain only the media-col-ready of which data size is relatively small. Japanese Patent Laid-Open No. 2019-171626 (Counterpart of US 20190303054 A1) also describes a technique taking a processing capability and a real-time property of the information processing apparatus into consideration. When transmitting prohibition information to an information processing apparatus, this technique receives information related to a setting that can be set in the information processing apparatus, reduces a size of original prohibition information with a large data size based on the received information, and transmits the reduced prohibition information to the information processing apparatus.

Further, an information processing apparatus that obtains only the media-col-ready can form an appropriate image by referring to the media-col-ready if media wanted by a user to print is already placed in the printer. However, there is a case where the media wanted by the user to print is not placed in the printer at a timing when the information processing apparatus issues a print instruction to the printer and the media is placed after issuing the print instruction. In this case, since the information processing apparatus cannot refer to the conditions that can be set for the media wanted by the user wants to print only with the media-col-ready, an appropriate image cannot be formed and a print result by the printer may be unintended by the user.

In this way, the information processing apparatus such as a mobile terminal having a low processing capability may not obtain the media-col-database because such an apparatus tends to avoid obtaining the data having a large size from the viewpoint of the real-time property due to the characteristics. In this case, when the user attempts to print on media that is not placed in the printer, the information processing apparatus may transmit image data generated in a direction or rotation unintended by the user to the printer because the information processing apparatus cannot refer to necessary information.

### SUMMARY

The present disclosure provides a mechanism that enables a printer to perform appropriate printing even if an information processing apparatus has a low processing capability.

Accordingly, an aspect of the embodiments provides a printer communicable with an information processing apparatus, the printer including a memory device that stores a set of instructions, and at least one processor that executes the set of instructions to receive first information relating to media selected by a user in the information processing apparatus, and output second information to print on the media selected in a case where the media selected is not placed in the printer.

Features of the present disclosure will become apparent from the following description of embodiments with reference to the attached drawings. The following description of embodiments is described by way of example.

### BRIEF DESCRIPTION OF THE DRAWINGS

FIG. 1 is a network configuration diagram schematically illustrating an environment of a network.

FIG. 2 is a functional block diagram of a client PC shown in FIG. 1.

FIG. 3 is a functional block diagram of a printer shown in FIG. 1.

FIG. 4 is a functional block diagram of a cloud print service shown in FIG. 1.

FIG. 5 is a sequence chart illustrating a process executed when the printer is registered in the cloud print service.

FIG. 6A, FIG. 6B, and FIG. 6C are views each of which illustrates an orientation of a long envelope (90mm × 205mm) is placed in a rear media feed tray of the printer.

FIG. 7 is a view illustrating examples of a request packet and a response packet about media-col-database.

FIG. 8 is a view illustrating examples of a request packet and a response packet about media-col-database-search-supported.

FIG. 9 is a view illustrating examples of a request packet and a response packet transmitted when combination data necessary for a long envelope (90mm × 205mm) is partially obtained from among data included in the media-col-database.

FIG. 10 is a sequence chart illustrating a process until a mobile terminal transmits a print job to the printer.

FIG. 11A to FIG. 11D are views illustrating examples of print setting UI screens in a case where only one media orientation can be selected.

FIG. 12A to FIG. 12D are views illustrating examples of print setting UI screens in a case where two media orientations can be selected.

FIG. 13 is a flowchart illustrating a process executed after the printer receives a capability obtainment request.

FIG. 14 is a flowchart illustrating a process executed by the mobile terminal in a first embodiment during a period from a user instruction to activate the print setting UI until transmitting a print job to the printer.

FIG. 15 is a flowchart illustrating a process executed by the mobile terminal in a second embodiment during a period from a user instruction to activate the print setting UI until transmitting a print job to the printer.

FIG. 16 is a flowchart illustrating a process executed by the printer when being notified of information about a processing capability of the mobile terminal in the second embodiment.

FIG. 17 is a flowchart illustrating a process executed by the mobile terminal in a third embodiment during a period from a user instruction to activate the print setting UI until transmitting a print job to the printer.

FIG. 18 is a flowchart illustrating a process executed by the mobile terminal in a fourth embodiment during a period from a user instruction to activate the print setting UI until transmitting a print job to the printer.

### DESCRIPTION OF THE EMBODIMENTS

Hereinafter, embodiments of the present disclosure will be described in detail with reference to the drawings. However, configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added. Any two or more configurations (features) of the embodiments can be combined.

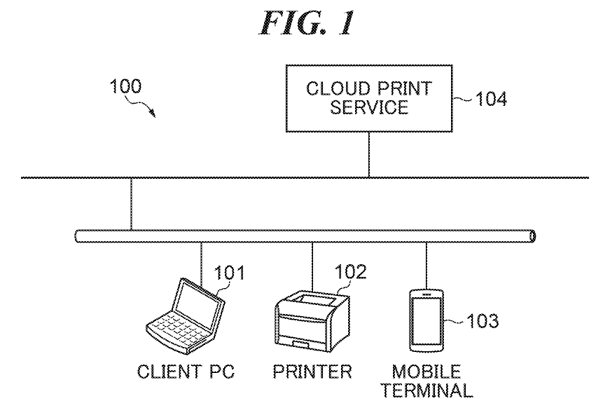

Hereinafter, a first embodiment will be described with reference to FIG. 1 to FIG. 14. FIG. 1 is a network configuration diagram schematically illustrating an environment of a network 100 in the first embodiment. A client PC 101 is connected to the network 100. A printer 102 and a mobile terminal 103 are connected to the same intranet as the client PC 101. The printer 102 may be a device specialized for a printing function or a multifunction peripheral having functions including a printing function. The network 100 is further connected to a cloud print service 104.

The cloud print service 104 is a service constructed on a cloud (that is, on a server system) by the server system constituted by servers, and is a service for print control on the Internet. The cloud print service 104 can be connected to each intranet, and can be directly connected to the client PC 101, the printer 102, and the mobile terminal 103 via the Internet. In the cloud print service 104, a user account is managed using a user ID and a password. Accordingly, a user can access the cloud print service 104 using a user account. The cloud print service 104 functions as a print server system. In this way, the print system is constructed in the network 100.

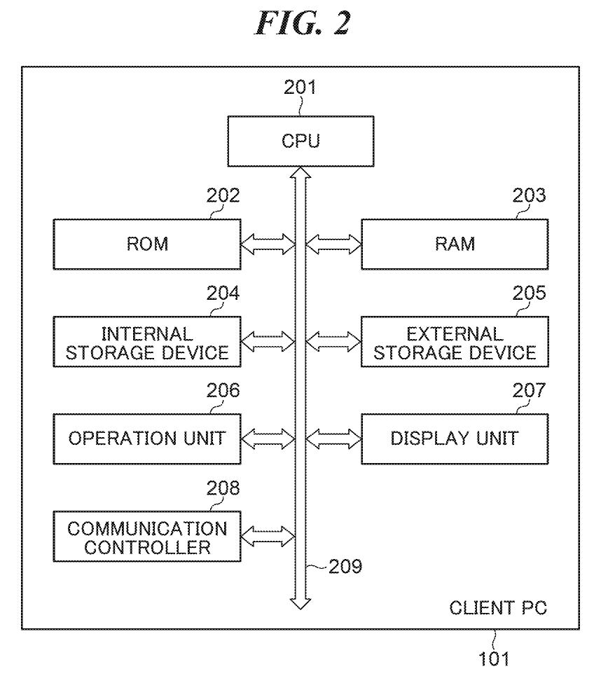

FIG. 2 is a functional block diagram of the client PC 101. In the client PC 101, a CPU 201, a ROM 202, a RAM 203, an internal storage device 204, an external storage device 205, an operation unit 206, a display unit 207, and a communication controller 208 are mutually connected via a system bus 209. The CPU 201 controls operations of the entire client PC 101 via the system bus 209 by reading a program stored in the ROM 202, the internal storage device 204, or the external storage device 205 to the RAM 203 and executing the program. The ROM 202 stores a control program and the like. The RAM 203 temporarily stores a program and image data so as to support a high speed operation of the client PC 101.

The internal storage device 204 stores an operating system (OS), various application programs, image data, and the like. Usually, the CPU 201 installs application software by controlling the external storage device 205. An OS standard print driver is initially installed in the client PC 101. That is, the OS standard print driver is included in the OS in advance. The OS standard print driver can generate print data printable by printers provided by a plurality of different makers (manufacturers, vendors) and transmit the print data to the printers provided by the plurality of different makers. The OS standard driver may be a printing function provided by the OS.

The operation unit 206 controls a keyboard (not shown) and a mouse (not shown) as user instruction input tools. The display unit 207 displays various screens for a user. The communication controller 208 is connected to the network 100 so as to connect the client PC 101 to an Internet provider and to perform data communication with the printer 102 and the cloud print service 104. Note that, the connection to the network 100 and its security shall be established by a known method, such as mDNS, HTTP, IPP, or TLS, and detailed description thereof will be omitted. The hardware components, such as the CPU 201, ROM 202, RAM 203, the internal storage device 204, and the external storage device 205, constitute a computer that develops and executes programs of sequence charts and flowcharts described later.

Since a functional block diagram of the mobile terminal 103 is common to that of the client PC 101, a detailed description thereof will be omitted. Therefore, the OS standard print driver is initially installed in the mobile terminal 103 as in the client PC 101. The OS standard print drivers of both the client PC 101 and the mobile terminal 103 use a print service in accordance with print standard specifications such as IPP (Internet Print Protocol), but may conform to WSD or the like. The OS standard print driver can use the print service by connecting to the cloud print service 104.

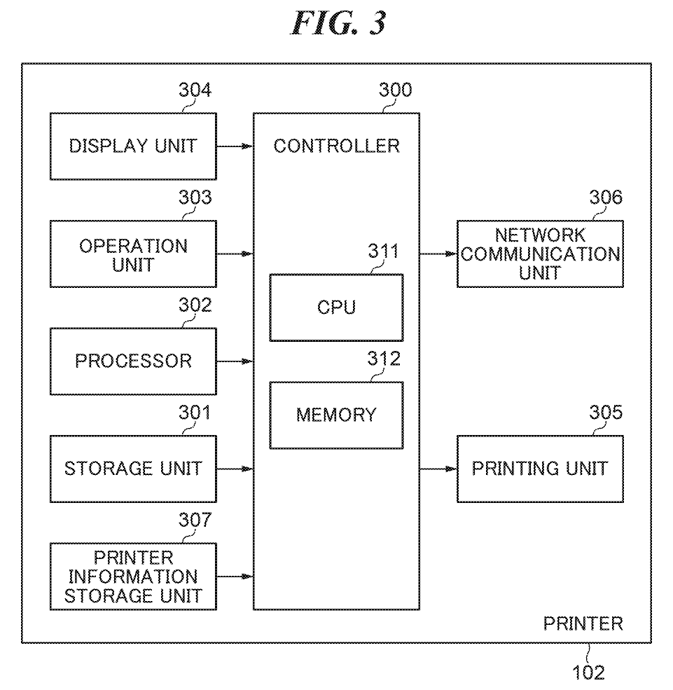

FIG. 3 is a functional block diagram of the printer 102. The printer 102 includes a controller 300, a storage unit 301, a processor 302, an operation unit 303, a display unit 304, a printing unit 305, a network communication unit 306, and a printer information storage unit 307. The controller 300 has a CPU 311 and a memory 312.

The controller 300 including the CPU 311 controls the entire operations of the printer 102. The CPU 311 performs various control processes, such as a print control process and a reading control process, by reading and executing a control program stored in the storage unit 301. The memory 312 is used as a work area or a temporary storage area to which various control programs are developed. The storage unit 301 stores print data, image data, various programs, and various kinds of setting information. Note that an auxiliary storage device such as an HDD is assumed as the storage unit 301, but a nonvolatile memory such as an SSD may be used. In this way, the CPU 311 and the hardware components, such as the memory 312 and the storage unit 301, constitute a computer that develops and executes programs of sequence charts and flowcharts described later.

The processor 302 has a function of an RIP (Raster Image Processor) that generates a print image by developing print data received via the network 100. Further, the processor 302 has a capability as an image processor, and can also perform an image resolution conversion process and an image correction process. Note that the processor 302 is assumed to be implemented by a hardware circuit (such as an ASIC or an FPGA), but this is not limited. For example, when the printer 102 includes a processor for image processing, the processor for the image processing may implement a development process and an image process of print data by executing an image processing program. Further, the development process and image process of print data may be implemented by the CPU 311 executing the program for performing the development process and image process of print data. Further, the development process and image process of print data may be implemented by any combination of the above-described configurations.

The operation unit 303 is provided with a liquid crystal display panel having a touch panel function, various hard keys, and the like. Therefore, the operation unit 303 functions as the display unit 304 displaying information and a reception unit that receives a user instruction. The operation unit 303 also function as a reading unit to reads a document and generate a read image. The generated read image is stored in the storage unit 301. The print image generated by the processor 302 analyzing the print data is transferred from the controller 300 to the printing unit 305. The printing unit 305 receives a control command and a print image via the controller 300, and prints the image on a sheet fed from a media feed cassette (not shown) based on the print image.

The controller 300 is connected to the network 100 via the network communication unit 306. The network communication unit 306 transmits an image and information to an apparatus on the network 100 and receives print data and information from the apparatus on the network 100. The printer information storage unit 307 stores a hardware ID that is an identifier for uniquely identifying the printer 102, and capability information. The printer information storage unit 307 may be included in the storage unit 301.

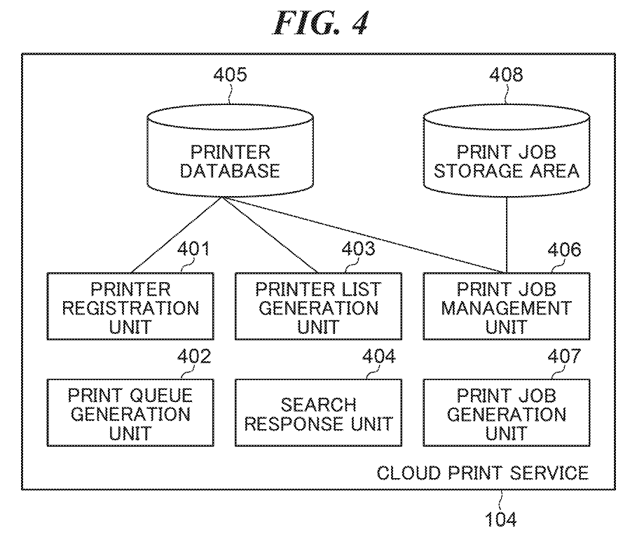

FIG. 4 is a functional block diagram of the cloud print service 104. The cloud print service 104 is a service that is configured on a cloud via the Internet and can provide functions related to printing. The cloud print service 104 includes, as functional units related to printing, a printer registration unit 401, a print queue generation unit 402, a printer list generation unit 403, a search response unit 404, and a printer database 405. The cloud print service 104 further includes a print job management unit 406, a print job generation unit 407, and a print job storage area 408 as functional units related to printing. These functional units may be included in another cloud print service that cooperates with the cloud print service 104.

When a list of registered printers (hereinafter, referred to as a “printer list”) is requested from the client PC 101 or the mobile terminal 103, the printer list generation unit 403 generates the printer list. The search response unit 404 responds to an event of a printer search from the client PC 101 or the mobile terminal 103 with information about the registered printer. The print job management unit 406 receives a print job from the client PC 101 or the mobile terminal 103, and directly sends the received job to the printer 102 depending on a situation. Alternatively, the print job management unit 406 temporarily stores the print job in the print job storage area 408, and passes the print job to the print job generation unit 407 at a timing when the printer of the output destination is determined, thereby converting the print job into an appropriate format and transmitting the print job. The printer registration unit 401, the print queue generation unit 402, and the printer database 405 will be described later.

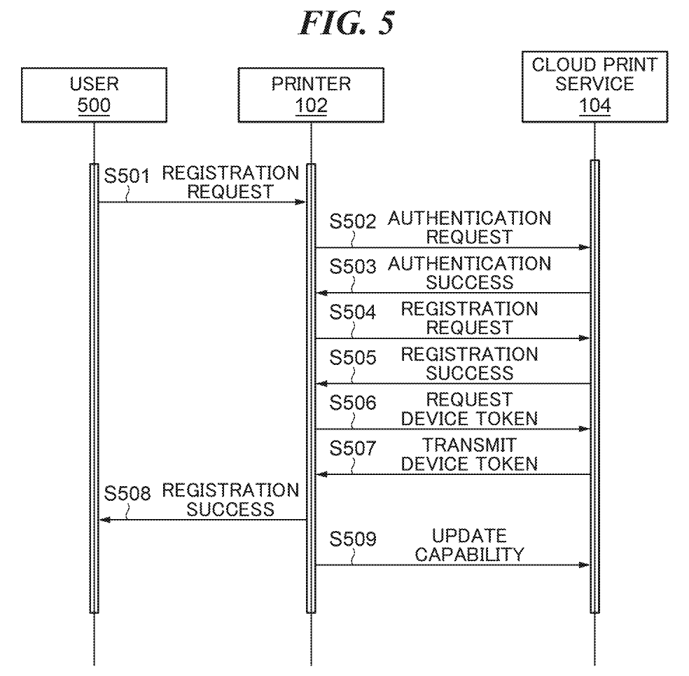

FIG. 5 is a sequence chart illustrating a process executed when the printer 102 is registered in the cloud print service 104. The sequence in FIG. 5 is started when the user 500 instructs the printer 102 to register in a step S501. At this time, the user 500 may operate the printer 102 to issue a registration request instruction or may access a web UI of the printer 102 from the client PC 101 or the mobile terminal 103 to issue a registration request instruction. In a step S502, the printer 102 makes an authorization request to the cloud print service 104. In this authentication request, the user 500 needs to input its own credential information to the URL for authentication returned from the cloud print service 104.

When the user 500 is successfully authenticated by inputting the credential information, the cloud print service 104 returns a user token to the printer 102 in a step S503 together with a response indicating that the user is successfully authenticated. In a step S504, the printer 102 requests a registered endpoint of the cloud print service 104 to register the user token returned in the step S503 as a Bearer token. At this time, in the cloud print service 104, the printer registration unit 401 generates a print queue using the print queue generation unit 402, and registers the generated print queue in the printer database 405 in association with printer identification information. In this manner, the printer 102 is registered in the printer database 405 in association with the print queue and the printer identification information.

In a step S505, the cloud print service 104 sends a response indicating that the printer 102 has been successfully registered to the printer 102. At this time, the printer 102 is notified of a device ID and a certificate in the cloud print service 104, a URL group for performing an operation on the cloud print service 104, and a URL for obtaining a device token necessary for performing the operation. In a step S506, the printer 102 requests the device token from the URL for obtaining the device token issued in the step S505. The certificate issued in the step S505 is attached to the request.

In a step S507, when the request in the step S506 is valid, the cloud print service 104 sends the device token to the printer 102. Note that the printer 102 attaches the device token sent in the step S507 as a Bearer token to an operation performed on the cloud print service 104 via the URL issued in the step S505. This enables the printer 102 to update the capability and obtain a job in the print queue corresponding to the printer itself existing on the cloud print service 104. In a step S508, the printer 102 notifies the user 500 of the success of the registration. At this time, the printer 102 may notify the user 500 with the display unit 304 or the web UI accessible from the client PC 101 or the mobile terminal 103.

In a step S509, the printer 102 updates the capability of the printer itself stored in the cloud print service 104. Specifically, the printer 102 notifies the URL issued in the step S505 of the IPP attribute corresponding to the IPP-Infra of the printer itself by update-output-devices that is an operation of the IPP-Infra. Upon receiving this notification, the cloud print service 104 rewrites the capability in the corresponding print queue in the printer database 405 with the capability indicated by the issued IPP attribute. The capability includes data of combinations of all media types described above, data of combinations of conditions that can be set for a finishing process, and the like. Although the cloud print service 104 has the authentication function in the sequence in FIG. 5, another cloud service that cooperates may have the authentication function, and the other cloud service may perform the above-described process.

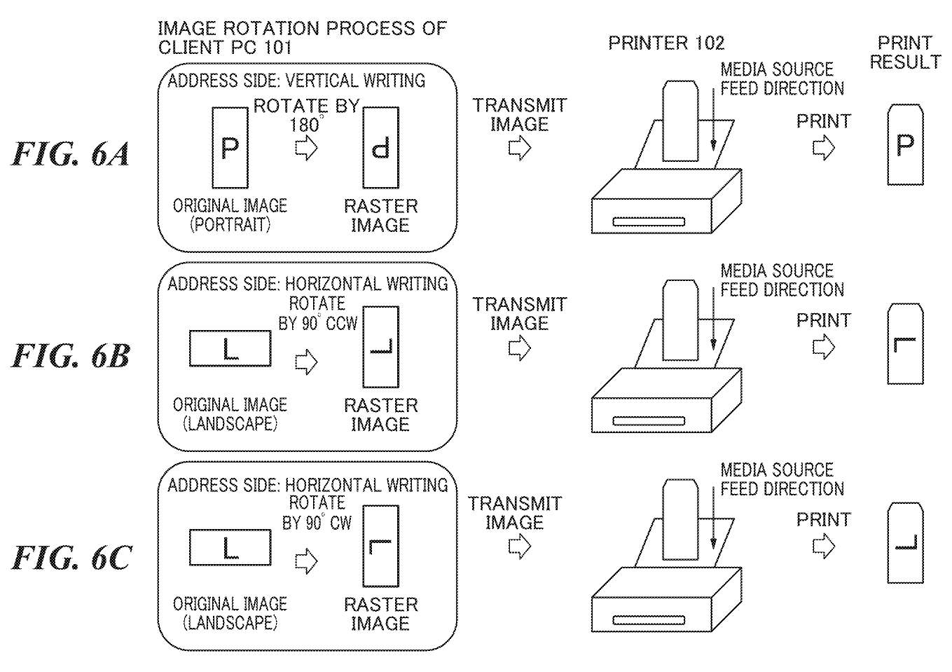

FIG. 6A, FIG. 6B, and FIG. 6C are views each of which illustrates an orientation of a long envelope (90mm × 205mm) is placed in a rear media feed tray of the printer 102. The printer 102 is configured to feed an envelope from the rear media feed tray. The rear media feed tray of the printer 102 can feed an envelope only from the short side of the envelope. In addition, the rear media feed tray of the printer 102 does not support media feeding from a flap of an envelope. Therefore, in any of the cases in FIG. 6A, FIG. 6B, and FIG. 6C, the feeding direction of the envelope on the rear media feed tray of the printer 102 is the same. A user needs to place an envelope on the rear media feed tray of the printer 102 so that a flap becomes a trailing end.

FIG. 6A is the view illustrating a printing method in a case of writing an address on an address side of an envelope vertically. In this case, the orientation of the original image is portrait. When transmitting an image to the printer 102 in a PWG-Raster format, the OS standard print driver needs to convert an original image into a raster image after the client PC 101 or the mobile terminal 103 appropriately rotates the original image. On the other hand, the user sets an envelope on the rear media feed tray of the printer 102 so that the flap of the envelope becomes the trailing end as described above. Therefore, as shown in FIG. 6A, when the initial letter “P” of portrait is printed, the OS standard print driver of the client PC 101 or the mobile terminal 103 rotates the original image by 180°, converts the rotated image into a raster image, and then transmits the raster image to the printer 102. As a result, the user can obtain a correct print result as intended.

FIG. 6B is the view illustrating a printing method in a case where an address is written horizontally on an address side of an envelope and a flap of the envelope is positioned to the left side of the address printed. In this case, the orientation of the original image is landscape. As shown in FIG. 6B, when the initial letter “L” of landscape is printed, the OS standard print driver of the client PC 101 or the mobile terminal 103 rotates the original image by 90° in counter clockwise (CCW), converts the rotated image into a raster image, and transmits the raster image to the printer 102. As a result, the user can obtain a correct print result as intended.

FIG. 6C is the view illustrating a printing method in a case where an address is written horizontally on an address side of an envelope and a flap of the envelope is positioned to the right side of the address printed. In this case, the orientation of the original image is landscape. As shown in FIG. 6C, when the initial letter “L” of landscape is printed, the OS standard print driver of the client PC 101 or the mobile terminal 103 rotates the original image by 90° in clockwise (CW), converts the rotated image into a aster image, and transmits the raster image to the printer 102. As a result, the user can obtain a correct print result as intended.

As described above, in order for the user to achieve an intended print result on a long envelope (90mm × 205mm) by the printer 102, the client PC 101 and the mobile terminal 103 need to correctly grasp a combination of a media feed direction in the printer 102 and a rotation direction. The data of the combination is included in the media-col-database or the media-col-ready as described above. Specifically, media-source-properties indicating options of feedable media include the feed direction as a value of a media-source-feed-direction. The direction of rotation is included as a value of media-source-feed-orientation.

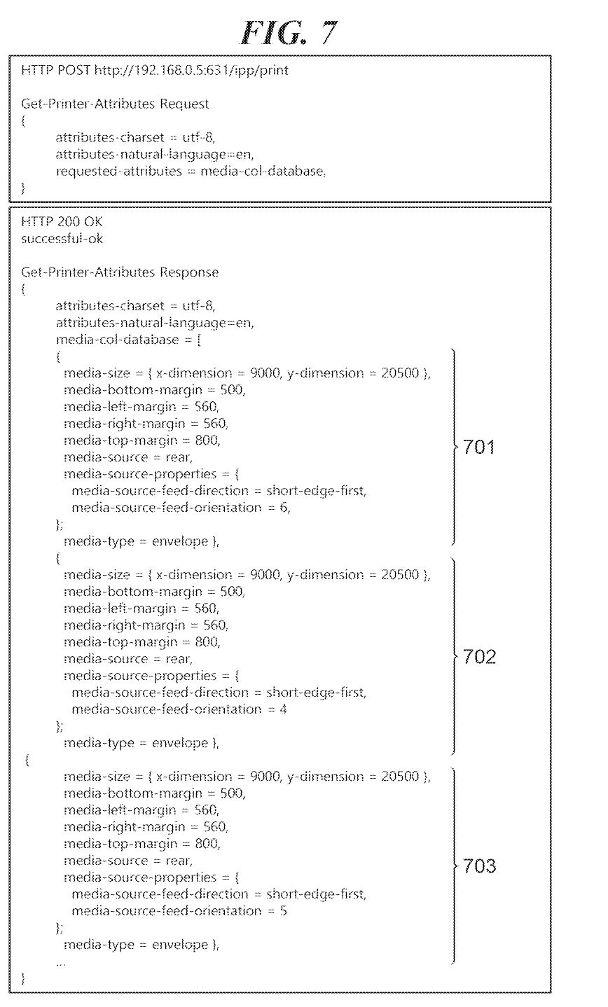

FIG. 7 shows examples of a request packet and a response packet about the media-col-database including the combinations of the media feed directions and the rotation directions shown in FIG. 6A, FIG. 6B, and FIG. 6C. In the response packet in FIG. 7, a first part 701 corresponds to FIG. 6A, a second part 702 corresponds to FIG. 6B, and a third part 703 corresponds to FIG. 6C. When the client PC 101 and the mobile terminal 103 are notified of a part 701, 702, or 703, they can recognize that the rotation shown in FIG. 6A, FIG. 6B, or FIG. 6C is required.

Although FIG. 7 shows the case where the media-col-database includes the data of the above combinations, if a long envelope (90mm × 205mm) is placed in the printer 102, the media-col-ready also includes the data of the same combination. Note that, since the media-col-database includes all data obtained by combining conditions that can be set for the media, when the printer 102 supports many media sizes and the like, the data size tends to become huge. Therefore, the media-col-database is less likely to be obtained by an information processing apparatus such as the mobile terminal 103 that emphasizes a real-time property due to concern about deterioration of the user experience. Therefore, when a function for partially obtaining only data of necessary combinations among data included in the media-col-database is provided, a print result as intended by the user can be obtained even by the information processing apparatus such as the mobile terminal 103 or the like.

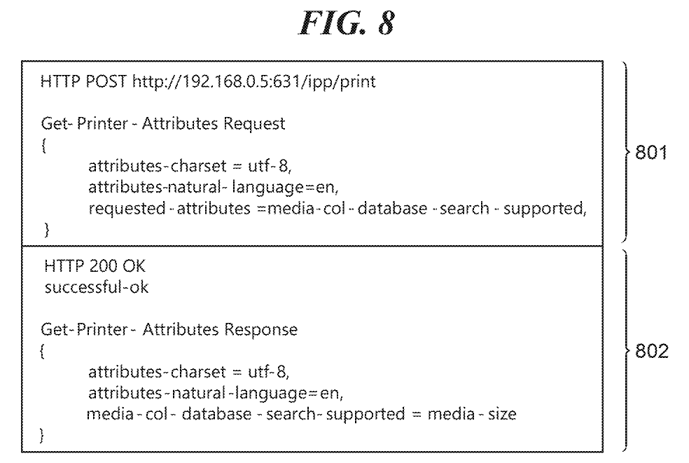

FIG. 8 is a view illustrating examples of a request packet 801 and a response packet 802 about media-col-database-search-supported. The request packet 801 of Get-Printer-Attributes is sent from the client PC 101 or the mobile terminal 103 to the printer 102. The response packet 802 of the Get-Printer-Attributes is sent from the printer 102 to the client PC101 or the mobile terminal 103.

In the first embodiment, an IPP attribute indicating whether partial obtainment from the media-col-database is supported is set to the media-col-database-search-supported. The IPP attribute can return, as a parameter, a retrieval key indicating that the printer 102 supports the partial obtainment from the media-col-database and indicating a range of the partial obtainment. The parameter to be returned includes, for example, a media-size. Values that the returned parameter can take are the same as that in the case of media-col-supported indicating the parameter supported by media-col. The IPP attribute corresponds to a third information indicating to have the function retrieving the second information from the information about all types of media printable by the printer 102.

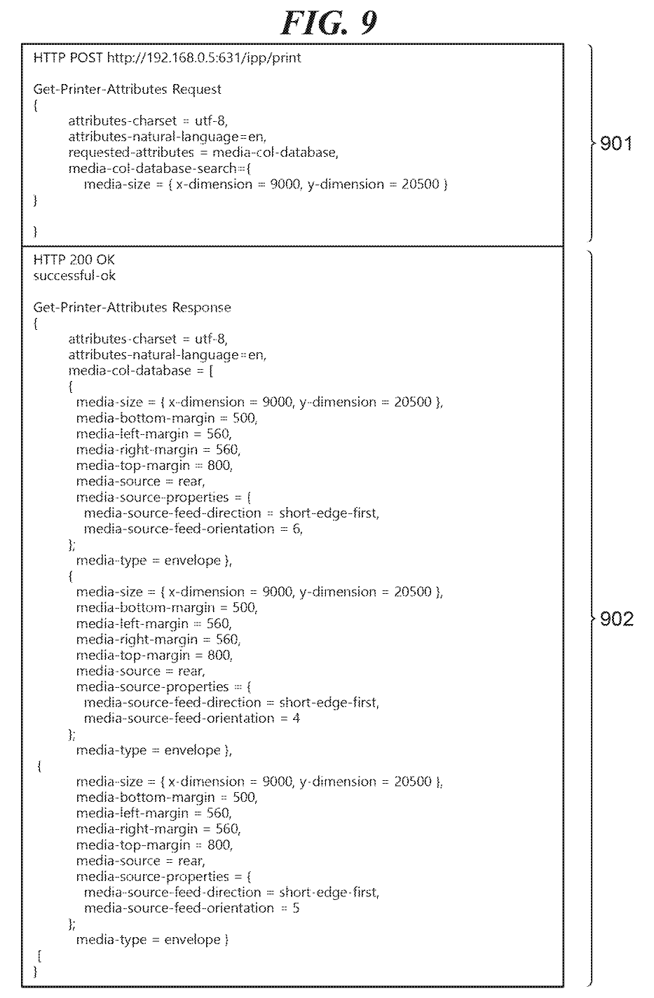

FIG. 9 is a view illustrating examples of a request packet 901 and a response packet 902 transmitted when combination data necessary for a long envelope (90mm × 205mm) is partially obtained from among data included in the media-col-database. The request packet 901 of the Get-Printer-Attributes is sent from the client PC 101 or the mobile terminal 103 to the printer 102. The response packet 902 of the Get-Printer-Attributes i sent from the printer 102 to the client PC 101 or the mobile terminal 103.

In the request packet 901, the media-col-database is designated in the Get-Printer-Attributes. Further, in the request packet 901, the size of the long envelope (90mm × 205mm) is specified for the media-col-database-search as an Operation attribute. Accordingly, the request packet 901 requests the printer 102 to transmit the data of the necessary combinations for a long envelope (90mm × 205mm) as the partial obtainment from the media-col-database. On the other hand, the response packet 902 responds only the data of the necessary combinations for a long envelope (90mm × 205mm) in accordance with the value designated to the media-col-database-search in the request packet 901.

In this way, the printer 102 responds to the client PC 101 or the mobile terminal 103 that the printer 102 supports the partial obtainment from the media-col-database by returning the retrieval key. On the other hand, the client PC 101 or the mobile terminal 103 requests the media-col-database from the printer 102 by designating the value belonging to the retrieval key of the partial obtainment form the media-col-database supported by the printer 102. This enables the partial obtainment form the media-col- database.

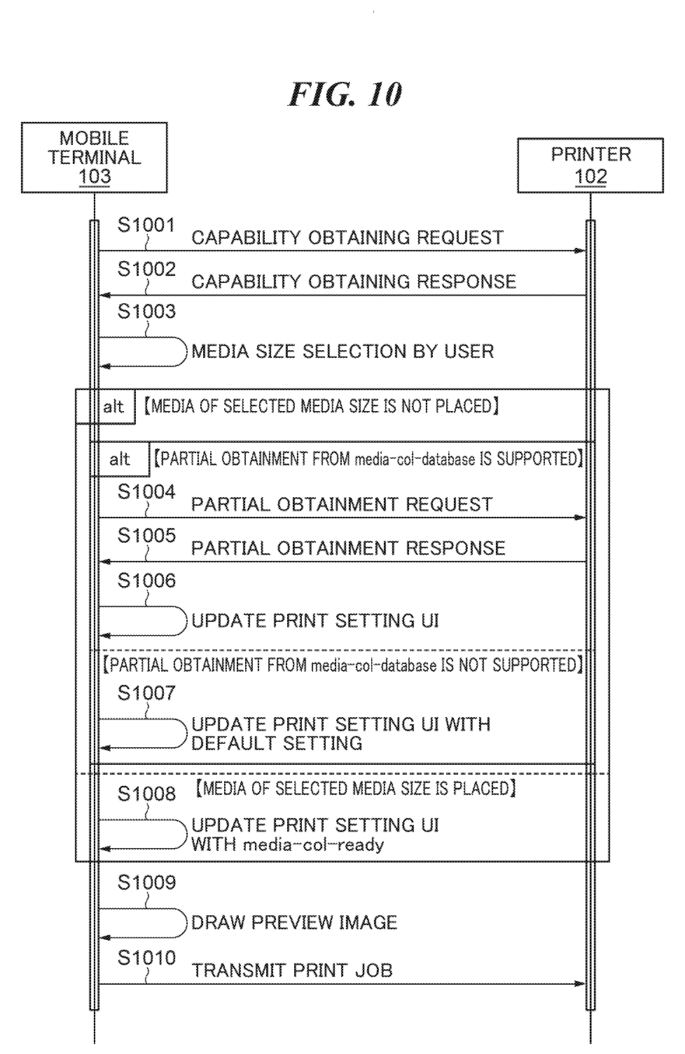

FIG. 10 is a sequence chart illustrating a process until the mobile terminal 103 transmits a print job to the printer 102. The sequence (printing method) shown in FIG. 10 (a control method of an information processing apparatus) is started when the user 500 selects the printer 102 and instructs the activation of the print setting UI in the mobile terminal 103. In a step S1001, upon receiving the instruction to activate the print setting UI, the mobile terminal 103 makes a capability obtaining request (a first request unit/a first request step). At this time, the mobile terminal 103 attempts to obtain the capability information using the Get-Printer-Attributes in order to obtain the necessary capability information from the printer 102. The capability information obtained in this manner includes color information, a media type, finishing, and a value of the media-col-database-search-supported. Note that the media-col-ready is obtained as the media-col and the media-col-database is not obtained.

Furthermore, media-size-supported, which holds a list of media sizes supported by the printer 102, and media-supported are obtained. Accordingly, the mobile terminal 103 can display the media size list even when the media-col-database is not obtained from the printer 102. This attribute indicates size information and a name in IPP of each of media supported by the printer 102, and does not include data such as a media feed direction and a rotation direction included in the media-col-database, and thus data size is small. Therefore, the mobile terminal 103 does not lose performance even if obtaining this attribute.

In a step S1002, the printer 102 performs a capability obtaining response (a first response unit/a first response step). At this time, the printer 102 responds to the mobile terminal 103 with the values corresponding to the attributes requested by the Get-Printer-Attributes in the step S1001. In a step S1003, the mobile terminal 103 generates and displays a print setting UI based on the values returned in the step S1002, and accepts a user operation to the print setting UI. Accordingly, the user can select the media size on the print setting UI of the mobile terminal 103.

Further, when both of the following conditions (1) and (2) are satisfied in the step S1003, the process proceeds to a step S1004.

(1) Media of the media size selected by the user is not placed in the printer 102.

(2) In the step S1002, the printer 102 has returned the retrieval key such as the media-size to the media-col-database-search-supported.

In the step S1004, the mobile terminal 103 makes a partial obtainment request (a second request unit/a second request step). At this time, the mobile terminal 103 designates the media size selected by the user in the step S1003 as a value included in the range of the partial obtainment indicated by the retrieval key returned in the step S1002, with respect to the media-col-database-search. In this way, the mobile terminal 103 requests the partial obtainment form the media-col-database from the printer 102 with the Get-Printer-Attributes. In a step S1005, the printer 102 performs a partial obtainment response (a second response unit/a second response step). At this time, the printer 102 receives the partial obtainment request as the first information related to the media selected by the user and responds to the mobile terminal 103 with a media-col list corresponding to the value designated to the media-col-database-search as the second information for printing on the selected media. In a step S1006, the mobile terminal 103 updates the current setting in the print setting UI based on the received media-col list.

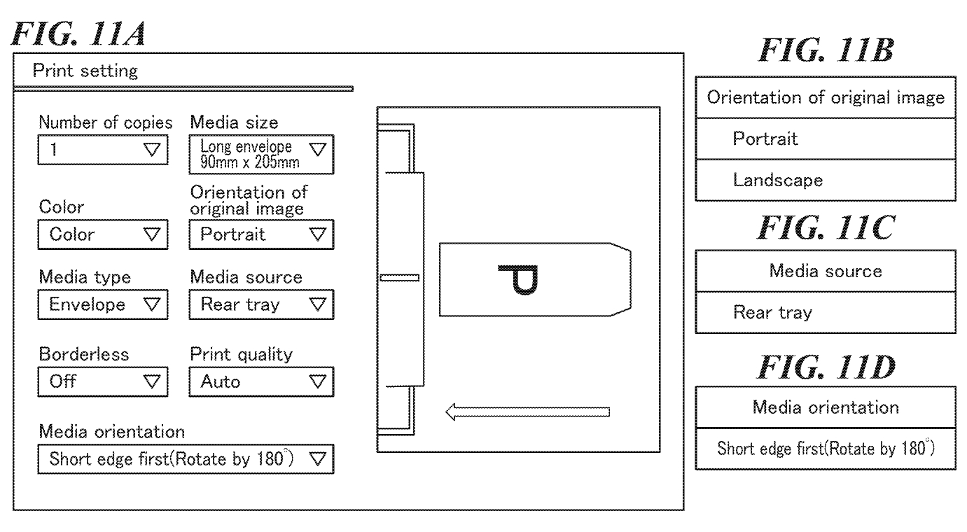

For example, when the media size selected by the user is a long envelop (90mm × 205mm) and the partial obtainment response in the step S1005 is the same as the response packet 902 in FIG. 9, and if the orientation of the image that the user wants to print is portrait, the screen of the print setting UI shown in FIG. 11A is displayed. At this time, it is desirable to display a preview image (an image of a print result according to a setting by a user) on the screen of the print setting UI as shown in FIG. 11A. In FIG. 11B, FIG. 11C, and FIG. 11D, values that can be taken in the current media size are listed based on the response packet 902 in FIG. 9.

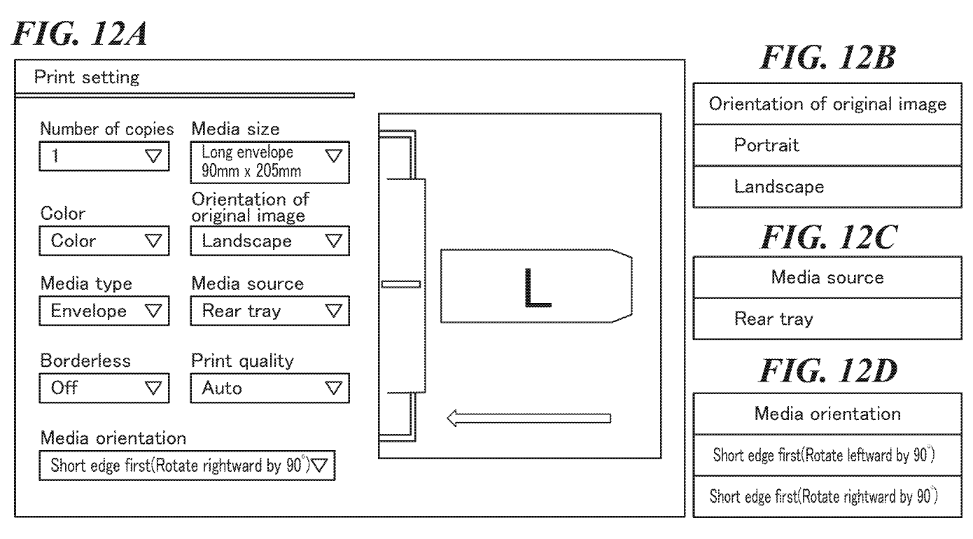

On the other hand, when the media size selected by the user is a long envelope (90mm × 205 mm) and the partial obtainment response in the step S1005 is the same as the response packet 902 in FIG. 9, and if the orientation of the image that the user wants to print is landscape, the screen of print setting UI shown in FIG. 12A is displayed. At this time, it is desirable to display a preview image (an image of a print result according to a setting by a user) on the screen of the print setting UI as shown in FIG. 12A. In FIG. 12B, FIG. 12C, and FIG. 12D, values that can be taken in the current media size are listed based on the response packet 902 in FIG. 9. The media-col list may be stored in the mobile terminal 103 and may be reused.

Returning to the description of FIG. 10. When the print setting UI of the mobile terminal 103 is updated in the step S1006 as described above, the process proceeds to a step S1009. In the step S1009, the mobile terminal 103 draws an image of a print result according to the selection by the user, that is, a preview image, on the print setting UI as shown in FIG. 11A and FIG. 12A. When the user issues a print instruction, the mobile terminal 103 performs an appropriate image process based on the print setting selected by the user and then transmits the print job to the printer 102 in a step S1010.

As described above, the data size of the obtained packet in the configuration that allows the partial obtainment form the media-col-database is smaller than that in the configuration in which only the media-col-database is collectively obtained. Therefore, even in the case of an information processing apparatus in which the media-col-database is not collectively obtained due to concern about performance, an appropriate print result desired by a user can be obtained by using the partial obtainment form the media-col-database.

In addition, in the step S1003, when both of the following conditions (3) and (4) are satisfied, the process proceeds to a step S1007.

(3) Media of the media size selected by the user is not placed in the printer 102.

(4) In the step S1002, the printer 102 has not returned the retrieval key such as the media-size to the media-col-database-search-supported.

In the step S1007, the mobile terminal 103 updates the current setting in the print setting UI based on the default setting corresponding to the media size selected by the user. For example, when an envelope is selected as the media type, the mobile terminal 103 may set the media orientation to “Short edge first (180° rotation)” on the print setting UI. Alternatively, the mobile terminal 103 may not accept the setting for rotating the media orientation on the print setting UI in order to increase the degree of freedom of the user. Thereafter, the processes in the steps S1009 and S1010 described above are performed.

In addition, in the step S1003, when the media of the media size selected by the user is placed in the printer 102, the process proceeds to a step S1008. In the step S1008, the mobile terminal 103 updates the current setting in the print setting UI based on the media-col-ready obtained in the step S1002. Thereafter, the processes in the steps S1009 and S1010 described above are performed.

In the sequence in FIG. 10, the information processing apparatus that communicates with the printer 102 is the mobile terminal 103, but the same process is performed even if the information processing apparatus is the client PC 101. Further, if the cloud print service 104 has the function of the partial obtainment, the cloud print service 104 may transmit a capability response indicating that the function of the partial obtainment is supported to the information processing apparatus such as the mobile terminal 103 even if the printer 102 does not have the function of partial obtainment. The same applies to processes of flowcharts described later.

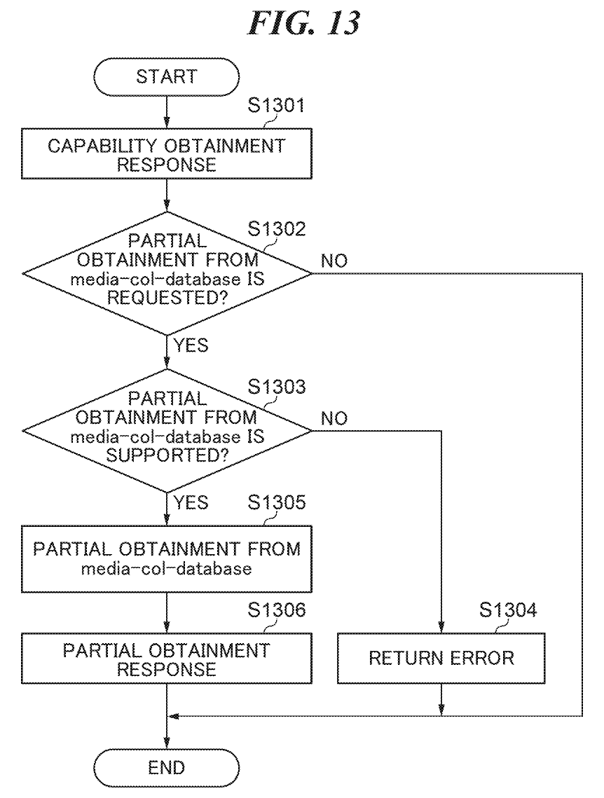

FIG. 13 is a flowchart illustrating a process executed after the printer 102 receives the capability obtainment request. The flowchart in FIG. 13 is started when the printer 102 receives the capability obtainment request from the mobile terminal 103. In a step S1301, the printer 102 sends the capability obtainment response to the mobile terminal 103. At this time, the printer 102 returns a value corresponding to the attribute requested by the Get-Printer-Attributes.

In a step S1302, the printer 102 determines whether the partial obtainment form the media-col-database is requested by the mobile terminal 103. In this determination, when the media-col-database-search is included in the Get-Printer-Attributes sent from the mobile terminal 103, it is determined that the partial obtainment form the media-col-database is requested. When the printer 102 determines that the partial obtainment form the media-col-database is not requested by the mobile terminal 103, the process of the flowchart in FIG. 13 ends. On the other hand, when the printer 102 determines that the partial obtainment form the media-col-database is requested by the mobile terminal 103, the process proceeds to a step S1303.

In the step S1303, the printer 102 determines whether the partial obtainment form the media-col-database requested by the mobile terminal 103 is supported. This determination is performed based on whether the value belonging to the retrieval key supported by the printer 102 is designated in the media-col-database-search in the Get-Printer-Attributes from the mobile terminal 103. When the printer 102 determines that the partial obtainment form the media-col-database requested by the mobile terminal 103 is supported, the process proceeds to a step S1305 described below. On the other hand, when the printer 102 determines that the partial obtainment form the media-col-database requested by the mobile terminal 103 is not supported, the process proceeds to a step S1304.

In the step S1304, the printer 102 returns an error indicating that the partial obtainment form the media-col-database requested by the mobile terminal 103 is not supported to the mobile terminal 103 (a third response unit). Thereafter, the flowchart in FIG. 13 ends. In the step S1305, the printer 102 performs the partial obtainment form the media-col-database requested by the mobile terminal 103. Accordingly, the media-col list corresponding to the value designated for the media-col-database-search is enumerated. In the next step S1306, the printer 102 makes a partial obtainment response to the mobile terminal 103. At this time, the printer 102 responds to the mobile terminal 103 with the media-col list enumerated in the above step S1305. Thereafter, the flowchart in FIG. 13 ends.

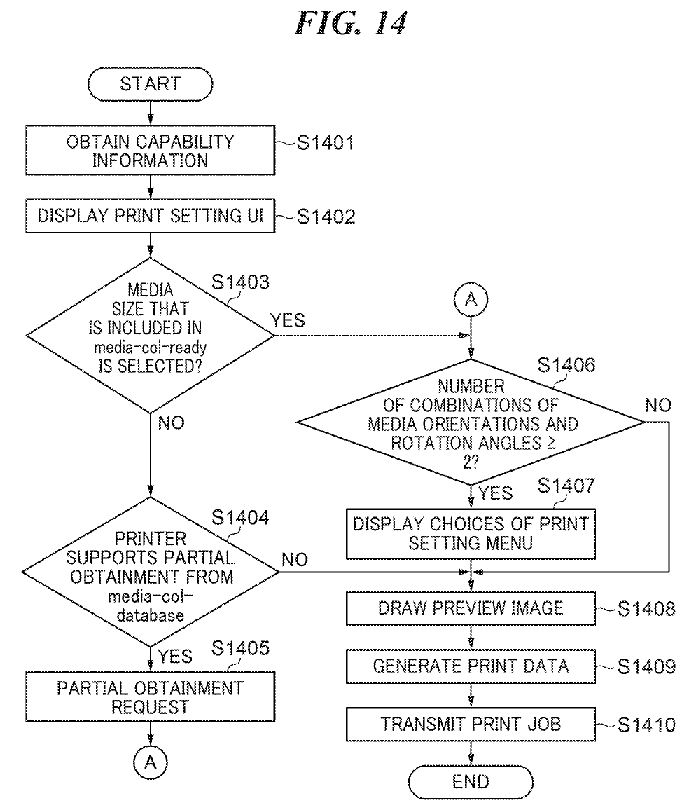

FIG. 14 is a flowchart illustrating a process executed by the mobile terminal 103 during a period from the instruction to activate the print setting UI by the user 500 until the transmission of the print job to the printer 102. The process of the flowchart in FIG. 14 is started when the user 500 selects the printer 102 and instructs the activation of the print setting UI in the mobile terminal 103. In a step S1401, the mobile terminal 103 obtains the required capability information from the printer 102. This process is performed in the same manner as the processes in the steps S1001 to S1002 described above. In a step S1402, the mobile terminal 103 generates and displays a print setting UI based on the necessary capability information obtained in the step S1401.

In a step S1403, the mobile terminal 103 determines whether a media size that is included in the media-col-ready obtained in the step S1401 is selected by the user 500 on the print setting UI. When the mobile terminal 103 determines that a media size that is included in the media-col-ready obtained in step S1401 is selected by the user 500 on the print setting UI, the process proceeds to a step S1406 described below. On the other hand, when the mobile terminal 103 determines that a media size that is not included in the media-col-ready obtained in the step S1401 is selected by the user 500 on the print setting UI, the process proceeds to a step S1404.

In the step S1404, the mobile terminal 103 determines whether the printer 102 supports the partial obtainment form the media-col-database. This determination is performed based on whether the media-col-database-search-supported is included in the necessary capability information obtained by the mobile terminal 103 in the step S1401. In this regard, when the media-col-database-search-supported is included, it is determined that the printer 102 supports the partial obtainment form the media-col-database. On the other hand, when the media-col-database-search-supported is not included, it is determined that the printer 102 does not support the partial obtainment form the media-col-database.

In this way, when the mobile terminal 103 determines that the printer 102 does not support the partial obtainment form the media-col-database, the process proceeds to a step S1408 described below. On the other hand, when the mobile terminal 103 determines that the printer 102 supports the partial obtainment form the media-col-database, the process proceeds to a step S1405. Note that the process may proceed to the step S1406 after the mobile terminal 103 collectively obtains the media-col-database. In the step S1405, the mobile terminal 103 requests the partial obtainment form the media-col-database from the printer 102. This process is performed in the same manner as the processes in the steps S1004 and S1005 described above.

In the step S1406, the mobile terminal 103 determines whether there are two or more data combinations of media orientations and rotation angles that can be applied to the media size selected by the user 500. The media orientation and the rotation angle refer to the media feed direction and the rotation direction included in the media-col-ready obtained in the step S1401 or the media-col list of the media-col-database obtained in the step S1405. When the mobile terminal 103 determines that there are not two or more data combinations of the sheet orientations and the rotation angles that can be applied to the media size selected by the user 500, the process proceeds to a step S1408 described later. On the other hand, when the mobile terminal 103 determines that there are two or more data combinations of the sheet orientations and the rotation angles that can be applied to the media size selected by the user 500, the process proceeds to a step S1407.

In the step S1407, the mobile terminal 103 displays the data combinations of the media orientations and the rotation angles that can be applied to the media size selected by the user 500 as choices of a print setting menu as illustrated in FIG. 12D described above. In the step S1408, the mobile terminal 103 draws a preview image. At this time, the mobile terminal 103 draws a preview image as shown in FIG. 11A or FIG. 12A based on the content of the print setting selected by the user 500 on the print setting UI. In a step S1409, the mobile terminal 103 generates print data. In a step S1410, the mobile terminal 103 transmits a print job including the print data to the printer 102. These processes are performed in the same manner as the process in the step S1010 described above. Thereafter, the flowchart in FIG. 14 ends.

As described above, even when the mobile terminal 103 that has obtained only the media-col-ready due to concern about performance, the partial obtainment form the media-col-database can be performed based on the selection by the user. As a result, even when the user selects the media that is not placed in the printer 102, an appropriate print result can be obtained. That is, in the first embodiment, even when the information processing apparatus such as the mobile terminal 103 obtains only the media-col-ready in consideration of the real-time property and the processing capability, the list of the conditions (the media-col list) necessary for the user can be obtained. Accordingly, even when a user attempts printing on media that is not placed in the printer 102, the information processing apparatus such as the mobile terminal 103 can form an appropriate image in consideration of the orientation and the rotation by referring to the obtained list of the conditions. In this manner, even if the processing capability of the information processing apparatus such as the mobile terminal 103 is low, the information processing apparatus can cause the printer 102 to perform appropriate printing on the media that is not currently placed.

A smartphone or a tablet terminal can be used as the information processing apparatus such as the mobile terminal 103 that obtains only the media-col-ready in consideration of the real-time performance and the processing capacity. Although the target of the partial obtainment is the media-col-database in the first embodiment, it may be data (a finishing-col-database) in which conditions that can be set for a finishing process are combined.

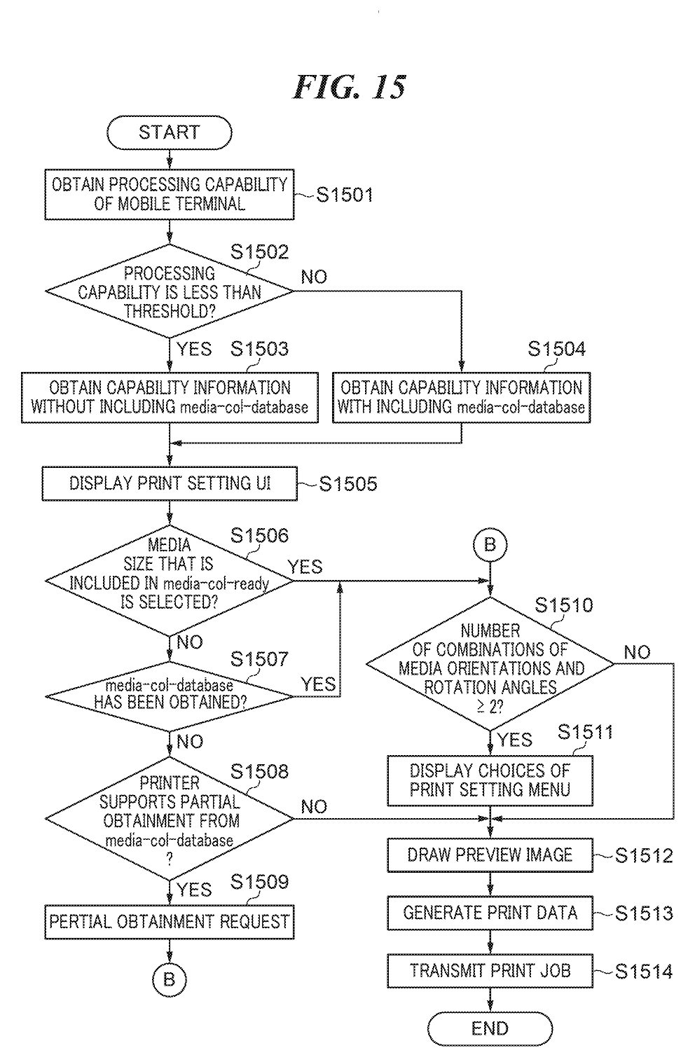

Hereinafter, a second embodiment will be described with reference to FIG. 15. The description of the second embodiment is focused on the differences from the first embodiment. In the first embodiment, the mobile terminal 103 that obtains only the media-col-ready performs the partial obtainment form the media-col-database after obtaining the information indicating that the partial obtainment form the media-col-database can be supported from the printer 102. However, since performances of mobile terminals are different depending on models, there are a case where it is preferred to perform the collective obtainment of the media-col-database and a case where it is preferred to perform the partial obtainment form the media-col-database. Therefore, in the second embodiment, a configuration in which the mobile terminal 103 selects the collective obtainment of the media-col-database or the partial obtainment form the media-col-database based on information about the processing capability of the mobile terminal 103 will be described. In the second embodiment, the process of the printer 102 is performed in the same manner as the process shown in FIG. 13.

FIG. 15 is a flowchart illustrating a process executed by the mobile terminal 103 during a period from the instruction to activate the print setting UI by the user 500 until the transmission of the print job to the printer 102. The process of the flowchart in FIG. 15 is started when the user 500 selects the printer 102 and instructs the activation of the print setting UI in the mobile terminal 103. In a step S1501, the mobile terminal 103 obtains the information about its processing capability. The processing capability of the mobile terminal 103 is found from capabilities of a CPU, a RAM, and a storage device.

In a step S1502, the mobile terminal 103 determines whether the processing capability of the mobile terminal 103 obtained in the step S1501 is less than a threshold. The threshold indicates a predefined reference, and is stored in an internal storage device of the mobile terminal 103. When the mobile terminal 103 determines that the processing capability of the mobile terminal 103 obtained in the step S1501 is not less than the threshold, the process proceeds to a step S1504 described below. On the other hand, when the mobile terminal 103 determines that the processing capability of the mobile terminal 103 obtained in the step S1501 is less than the threshold, the process proceeds to a step S1503.

In the step S1503, the mobile terminal 103 obtains the capability information necessary to display the print setting UI from the printer 102. At this time, the media-col-database that heightens processing load of the mobile terminal 103 is not obtained. Thereafter, the process proceeds to a step S1505 described later. In the step S1504, the mobile terminal 103 obtains the necessary capability information from the printer 102 in the same manner as in the step S1503 described above. However, in the step S1504, the media-col-database is also obtained. That is, the media-col-database is collectively obtained. The processes in steps S1505 and S1506 are performed in the same manner as the processes in the steps S1402 and S1403 described above.

In a step S1507, the mobile terminal 103 determines whether the media-col-database has been obtained. That is, it is determined whether the media-col-database has been collectively obtained. When the mobile terminal 103 determines that the media-col-database has been obtained, the process proceeds to a step S1510 described below. On the other hand, when the mobile terminal 103 determines that the media-col-database has not been obtained, the process proceeds to a step S1508. The processes in steps S1508 to S1514 are performed in the same manner as the processes in the steps S1404 to S1410 described above.

As described above, the mobile terminal 103 can select and perform the collective obtainment of the media-col-database or the partial obtainment form the media-col-database based on the processing capability of the mobile terminal 103. This provides an appropriate user experience in the second embodiment.

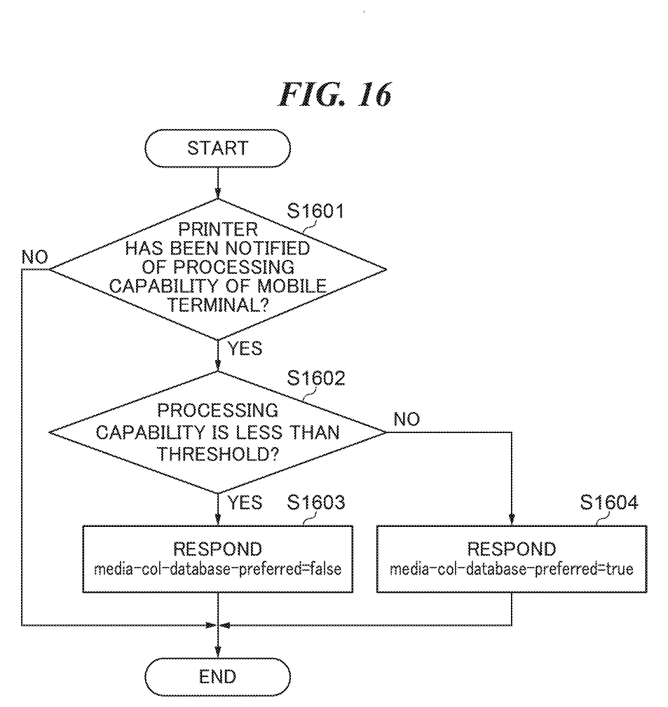

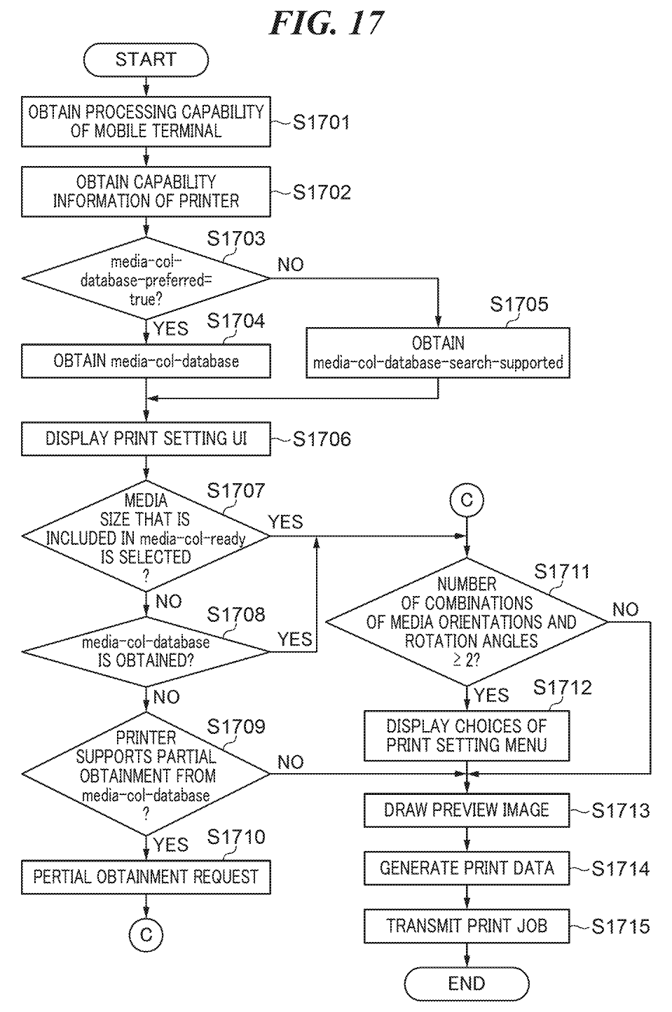

Hereinafter, a third embodiment will be described with reference to FIG. 16 and FIG. 17. The description of the third embodiment is focused on the differences from the second embodiment. In the third embodiment, a configuration in which the mobile terminal 103 notifies the printer 102 of information about the processing capability of the mobile terminal 103 and the printer 102 determines whether to recommend the collective obtainment of the media-col-database based on the information about the processing capability of the mobile terminal 103 will be described. FIG. 16 is a flowchart illustrating a process executed by the printer 102 when being notified of information about the processing capability of the mobile terminal 103.

In a step S1601, the printer 102 determines whether the printer 102 has been notified of the information about the processing capability of the mobile terminal 103. The printer 102 is notified of the information about the processing capability of the mobile terminal 103 by the Operation attribute in the Get-Printer-Attributes. When the printer 102 determines that the printer 102 has not been notified of the information about the processing capability of the mobile terminal 103, the flowchart in FIG. 16 is terminated. On the other hand, when the printer 102 determines that the printer 102 has been notified of the information about the processing capability of the mobile terminal 103, the process proceeds to a step S1602.

In the step S1602, the printer 102 determines whether the processing capability of the mobile terminal 103 is less than a threshold. The threshold indicates a predefined reference, similarly to the second embodiment. However, the threshold is different from that in the second embodiment and is stored in the storage unit 301 of the printer 102. When the printer 102 determines that the processing capability of the mobile terminal 103 is not less than the threshold, the process proceeds to a step S1604 described below. On the other hand, when the printer 102 determines that the processing capability of the mobile terminal 103 is less than the threshold, the process proceeds to a step S1603.

In the step S1603, the printer 102 responds to the mobile terminal 103 with “media-col-database-preferred = false” indicating that it is preferred not to perform the collective obtainment of the media-col-database. This response is made by the Operation attribute together with the IPP attribute specified in the Requested-Attributes to the Get-Printer-Attributes requested in the step S1601. Thereafter, the flowchart in FIG. 16 ends.

In the step S1604, the printer 102 responds with “media-col-database-preferred = true” indicating that it is preferred to perform collective obtainment of the media-col-database. This response is also made by the Operation attribute together with the IPP attribute specified in the Requested-Attributes to the Get-Printer-Attributes requested in the step S1601. Thereafter, the flowchart in FIG. 16 ends.

By the above process, the printer 102 is notified of the information about the processing capability of the mobile terminal 103, and thus the printer 102 can determine whether to recommend the collective obtainment of the media-col-database that heightens the processing load.

FIG. 17 is a flowchart illustrating a process executed by the mobile terminal 103 during a period from the instruction to activate the print setting UI by the user 500 until the transmission of a print job to the printer 102. The process of the flowchart in FIG. 17 is started when the user 500 selects the printer 102 and instructs the activation of the print setting UI in the mobile terminal 103. In a step S1701, the mobile terminal 103 obtains the information about its processing capability.

In the step S1702, the mobile terminal 103 obtains the capability information necessary to display the print setting UI from the printer 102. However, the necessary capability information obtained from the printer 102 does not include the media-col-database. At this time, the mobile terminal 103 notifies the printer 102 of the information about the processing capability of the mobile terminal 103 obtained in the step S1701 by using the Operation property of the Get-Printer-Attributes.

In a step S1703, the mobile terminal 103 determines whether “media-col-database-preferred = true” is obtained in the step S1702. When the mobile terminal 103 determines that “media-col-database-preferred = true” is not obtained in the step S1702, the process proceeds to a step S1705 described below. That is, when “media-col-database-preferred = false” is obtained in the step S1702, the process proceeds to the step S1705. On the other hand, when the mobile terminal 103 determines that “media-col-database-preferred = true” is obtained in the step S1702, the process proceeds to a step S1704.

In the step S1704, the mobile terminal 103 collectively obtains the media-col-database using the Get-Printer-Attributes to the printer 102. Thereafter, the process proceeds to a step S1706 described later. In the step S1705, the mobile terminal 103 obtains media-col-database-search-supported using the Get-Printer-Attributes to the printer 102. Note that the media-col-database-search-supported is the IPP attribute indicating whether the partial obtainment form the media-col-database is supported, as described above. In the step S1706, the mobile terminal 103 displays the print setting UI based on the information obtained from the printer 102. The processes in steps S1707 to S1715 are performed in the same manner as the processes in the steps S1506 to S1514 described above.

As described above, the mobile terminal 103 can perform the collective obtainment of the media-col-database or the partial obtainment form the media-col-database according to the result of the determination by the printer 102 based on the processing capability of the mobile terminal 103. This provides an appropriate user experience in the third embodiment.

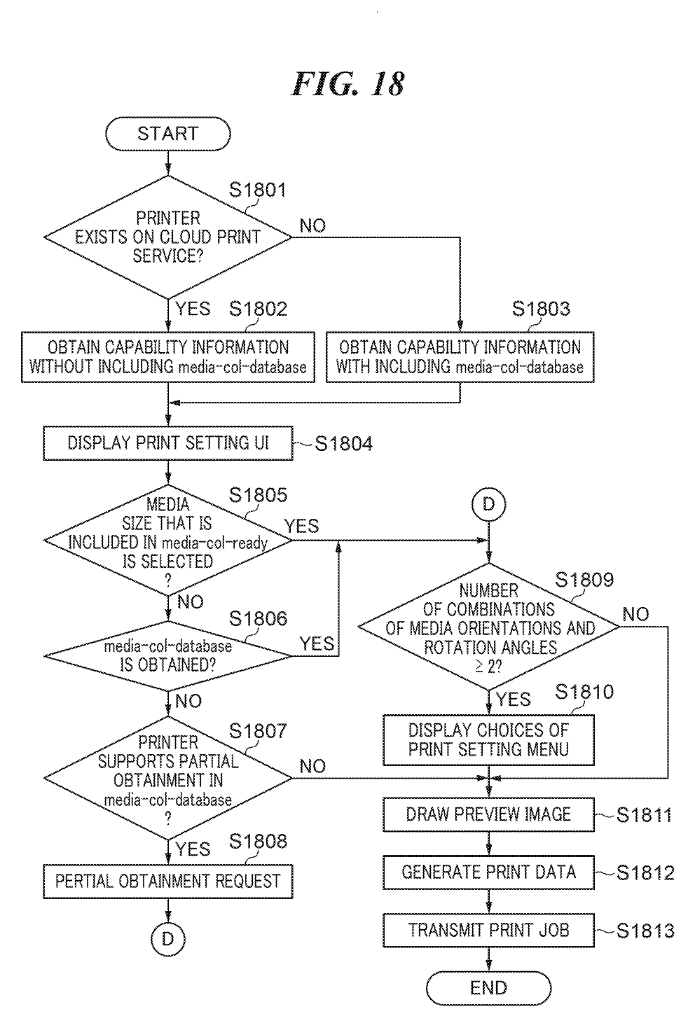

Hereinafter, a fourth embodiment will be described with reference to FIG. 18. The description of the fourth embodiment is focused on the differences from the second embodiment. In fourth embodiment, a configuration in which the mobile terminal 103 determines whether to collectively obtain the media-col-database depending on whether the printer 102 exists on the cloud print service 104 will be described.

FIG. 18 is a flowchart illustrating a process executed by the mobile terminal 103 during a period from the instruction to activate the print setting UI by the user 500 until the transmission of the print job to the printer 102. The process of the flowchart in FIG. 18 is started when the user 500 selects the printer 102 and instructs the activation of the print setting UI in the mobile terminal 103. In a step S1801, the mobile terminal 103 determines whether the printer 102 exists on the cloud print service 104. In this determination, when the printer 102 includes an access endpoint of the cloud print service 104, the printer 102 is determined to exist on the cloud print service 104. This determination may be performed based on whether a response to the request for the printer list registered in the cloud print service 104 has been made.

When the mobile terminal 103 determines that the printer 102 exists on the cloud print service 104, the process proceeds to a step S1802. On the other hand, when the mobile terminal 103 determines that the printer 102 does not exist on the cloud print service 104, for example, when the printer 102 exists on the local area network, the process proceeds to a step S1803. The processes in steps S1802 to S1813 are performed in the same manner as the processes in the steps S1503 to S1514 described above.

As described above, the mobile terminal 103 can select and perform the collective obtainment of the media-col-database or the partial obtainment form the media-col-database depending on whether the printer 102 exists on the cloud print service 104. This provides an appropriate user experience in the fourth embodiment.

According to the present disclosure, even the information processing apparatus having a low processing capability can cause the printer to perform appropriate printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227790, filed December 24, 2024 which is hereby incorporated by reference herein in its entirety.

What is claimed is:

1. A printer communicable with an information processing apparatus, the printer comprising:
a memory device that stores a set of instructions; and
at least one processor that executes the set of instructions to:
receive first information relating to media selected by a user in the information processing apparatus; and
output second information to print on the media selected in a case where the media selected is not placed in the printer.

2. The printer according to claim 1, wherein the first information is a retrieval key to output the second information.

3. The printer according to claim 1, wherein the first information is related to a media size.

4. The printer according to claim 1, wherein the second information includes at least one of a feed direction and a rotation direction.

5. The printer according to claim 1, wherein third information indicating that a function to retrieve the second information from information about all types of media that can be printed by the printer is provided can be output to the information processing apparatus.

6. The printer according to claim 1, wherein the second information is included in media-col-database.

7. The printer according to claim 1, wherein the second information is output as a response to get-printer-attributes of an Internet Print Protocol.

8. A control method for a printer communicable with an information processing apparatus, the control method comprising:
receiving first information relating to media selected by a user in the information processing apparatus; and
outputting second information to print on the media selected in a case where the media selected is not placed in the printer.

9. A non-transitory computer-readable storage medium storing a control program causing a computer to execute a control method for a printer communicable with an information processing apparatus, the control method comprising:
receiving first information relating to media selected by a user in the information processing apparatus; and
outputting second information to print on the media selected in a case where the media selected is not placed in the printer.
